(19) United States
(12) Patent Application Publication
(10) Pub. No.: US 2025/0300733 A1
(43) Pub. Date: Sep. 25, 2025

(54) POLARIZATION FLUCTUATION DETECTION METHOD, POLARIZATION FLUCTUATION DETECTION APPARATUS, AND POLARIZATION FLUCTUATION DETECTION SYSTEM

(71) Applicant: NEC Corporation, Tokyo (JP)

(72) Inventor: Yusuke SASAKI, Tokyo (JP)

(73) Assignee: NEC Corporation, Tokyo (JP)

(21) Appl. No.: 19/003,072

(22) Filed: Dec. 27, 2024

(30) Foreign Application Priority Data
Mar. 25, 2024 (JP) 2024-048244

(51) Int. Cl. H04B 10/2507; H04B 10/61; H04J 14/06

(52) U.S. Cl. CPC H04B 10/2572; H04J 14/06; H04B 10/6162

(57) ABSTRACT

A polarization fluctuation detection apparatus receives a plurality of optical signals output from the transmitter through a transmission line through which the plurality of optical signals are transmitted in a predetermined direction at propagation velocities different from each other. The polarization fluctuation detection apparatus includes a fluctuation detection unit configured to detect polarization fluctuations of the plurality of received optical signals, and an estimation unit configured to estimate a position where the polarization fluctuation has occurred in the transmission line based on a difference between the times at which the polarization fluctuations are detected in the plurality of optical signals.

### INCORPORATION BY REFERENCE

This application is based upon and claims the benefit of priority from Japanese patent application No. 2024-048244, filed on Mar. 25, 2024, the disclosure of which is incorporated herein in its entirety by reference.

### TECHNICAL FIELD

The present disclosure relates to a polarization fluctuation detection method, a polarization fluctuation detection apparatus, and a polarization fluctuation detection system.

### BACKGROUND ART

In order to achieve an increase in capacity of communication systems, polarization multiplexing digital coherent communication has been introduced. In the polarization multiplexing digital coherent communication, state of polarization (SOP) fluctuation may occur in a transmitted signal. Factors that lead to SOP fluctuation include factors such as construction vibration, lightning, car traffic, an earthquake, and wind. If a rapid SOP fluctuation occurs, polarization compensation in equalization processing cannot follow the polarization fluctuation, and as a result, an error may occur. Therefore, a monitoring system that monitors the polarization fluctuation that causes an error and detects the polarization fluctuation is important. In particular, in a case where a polarization fluctuation has occurred, it is important to specify or estimate the location where the polarization fluctuation has occurred.

As related art, Japanese Unexamined Patent Application Publication No. H6-307896 discloses a distributed waveguide sensor that detects a physical phenomenon acting on any position of a waveguide such as an optical fiber. The distributed waveguide sensor disclosed in Japanese Unexamined Patent Application Publication No. H6-307896 uses two sets of electromagnetic waves transmitted in opposite directions in a waveguide in order to estimate a position where a physical phenomenon has occurred. In the distributed waveguide sensor, a signal recognition unit analyzes a time relation between the state changes of two sets of the electromagnetic waves transmitted in opposite directions, which occur in a case where a physical phenomenon acts on the waveguide, and estimates a position where the physical phenomenon has occurred.

In the distributed waveguide sensor disclosed in Japanese Unexamined Patent Application Publication No. H6-307896, the state changes of two sets of the electromagnetic waves transmitted in opposite directions to each other are detected at both ends of the waveguide. In general, a distance from the position where a physical phenomenon has occurred to one end of the waveguide is different from a distance from the position where the physical phenomenon has occurred to the other end of the waveguide. In other words, a distance from a position where the physical phenomenon has occurred to one receiving end where an electromagnetic wave is detected is different from a distance from the position where the physical phenomenon has occurred to the other receiving end where an electromagnetic wave is detected. In this case, if physical phenomena have occurred at a plurality of locations in the waveguide, it is sometimes difficult to associate the state changes detected at one end side with the state changes detected at the other end side. If the state changes detected in both the electromagnetic waves cannot be correctly associated with each other, positions where the physical phenomena have occurred cannot be correctly estimated.

### SUMMARY

One of the objects of the present disclosure is to provide a polarization fluctuation detection method, a polarization fluctuation detection apparatus, and a polarization fluctuation detection system by which it is possible to estimate, even in a case where polarization fluctuations have occurred at a plurality of points in a transmission line, positions where the polarization fluctuations have occurred.

A polarization fluctuation detection method according to a first example aspect of the present disclosure includes: detecting polarization fluctuations of a plurality of optical signals transmitted through a transmission line in a predetermined direction at propagation velocities different from each other; and estimating a position where the polarization fluctuation has occurred in the transmission line based on a difference between the times at which the polarization fluctuations are detected in the plurality of optical signals.

A polarization fluctuation detection apparatus according to a second example aspect of the present disclosure includes: a fluctuation detection unit configured to detect polarization fluctuations of a plurality of optical signals transmitted through a transmission line in a predetermined direction at propagation velocities different from each other; and an estimation unit configured to estimate a position where the polarization fluctuation has occurred in the transmission line based on a difference between the times at which the polarization fluctuations are detected in the plurality of optical signals.

A polarization fluctuation detection system according to a third example aspect of the present disclosure includes: a transmitter configured to output a plurality of optical signals; and a polarization fluctuation detection apparatus configured to receive the plurality of optical signals output from the transmitter through a transmission line through which the plurality of optical signals are transmitted in a predetermined direction at propagation velocities different from each other, the polarization fluctuation detection apparatus including: a fluctuation detection unit configured to detect polarization fluctuations of the plurality of received optical signals; and an estimation unit configured to estimate a position where the polarization fluctuation has occurred in the transmission line based on a difference between the times at which the polarization fluctuations are detected in the plurality of optical signals.

A polarization fluctuation detection method, a polarization fluctuation detection apparatus, and a polarization fluctuation detection system according to the present disclosure can estimate, even in a case where polarization fluctuations have occurred at a plurality of points in a transmission line, positions where the polarization fluctuations have occurred.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram showing an example of a configuration of a polarization fluctuation detection system according to the present disclosure;

FIG. 2 is a block diagram showing an example of a configuration of a polarization fluctuation detection apparatus;

FIG. 3 is a waveform diagram showing a specific example of detection of a polarization fluctuation;

FIG. 4 is a schematic diagram showing a specific example of estimation of a position where a polarization fluctuation has occurred;

FIG. 5 is a flowchart showing an operation procedure of the polarization fluctuation detection apparatus;

FIG. 6 is a block diagram showing an example of a configuration of an optical fiber communication system;

FIG. 7 is a block diagram showing an example of a configuration of an optical transmitter;

FIG. 8 is a block diagram showing an example of a configuration of an optical receiver; and

FIG. 9 is a block diagram showing an example of a configuration of a signal processing circuit that may be used as the polarization fluctuation detection apparatus.

### EXAMPLE EMBODIMENT

Hereinafter, example embodiments of the present disclosure will be explained in detail. Note that the following description and the drawings are omitted and simplified as appropriate for clarity of explanation. In the drawings, the same elements and the similar elements are denoted by the same reference numerals, and redundant explanations are omitted as necessary.

FIG. 1 is a block diagram showing an example of a configuration of a polarization fluctuation detection system according to the present disclosure. An example embodiment of the present disclosure will be described with reference to FIG. 1. As shown in FIG. 1, a polarization fluctuation detection system 10 includes a transmitter 11 and a polarization fluctuation detection apparatus 15. In the polarization fluctuation detection system 10, the transmitter 11 is disposed at one end of a transmission line 13, that is, at a first end. Further, the polarization fluctuation detection apparatus 15 is disposed at the other end of the transmission line 13, that is, at a second end which is an end opposite to the first end.

The transmitter 11 outputs a plurality of optical signals. The transmitter 11 includes, for example, a plurality of light sources respectively corresponding to a plurality of optical signals, and outputs the optical signals output from the plurality of light sources to the transmission line 13. The transmitter 11 outputs, for example, two optical signals, that is, a first optical signal and a second optical signal, to the transmission line 13. The plurality of optical signals output from the transmitter 11 are multiplexed in the transmission line 13 and received by the polarization fluctuation detection apparatus 15 which is a receiver.

In the transmission line 13, a group delay velocity difference occurs in a plurality of optical signals to be transmitted. In other words, the transmission line 13 transmits a plurality of optical signals from the transmitter 11 side to the polarization fluctuation detection apparatus 15 side at propagation velocities different from each other.

In the transmission line 13, a plurality of optical signals may be multiplexed by fiber multiplexing. For example, the transmission line 13 includes a plurality of optical fibers. Refractive index distributions of the plurality of optical fibers are different from each other. In the transmission line 13, the plurality of optical fibers, for example, are inserted into a sheath of an optical fiber cable constituting the transmission line 13. The plurality of optical signals output from the transmitter 11, for example, are input to different optical fibers in the optical fiber cable, and are transmitted to the polarization fluctuation detection apparatus 15. In the transmission line 13, the plurality of optical signals are transmitted at different propagation velocities in accordance with a difference between the refractive index distributions of the optical fibers through which they are transmitted.

Specifically, the transmission line 13 may include a first optical fiber which is a single-mode fiber in conformity to the International Telecommunication Union-Telecommunication sector (ITU-T) G.652 standard, and a second optical fiber which is a Cutoff Shifted Fiber (CSF) in conformity to the ITU-T G.654 standard. The first optical signal is transmitted using the first optical fiber, and the second optical signal is transmitted using the second optical fiber. The group delay time per unit length of the first optical fiber is, for example, 4.901 (μs/km). Further, the group delay time per unit length of the second optical fiber is 4.883 (μs/km). In this case, the time required for the first optical signal and the second optical signal to reach the receiving end from the transmitting end varies in accordance with a difference between the group delay times of the optical fibers of two types.

In the transmission line 13, a plurality of optical signals may be multiplexed by core multiplexing using a multi-core fiber. In this case, the transmission line 13 includes a multi-core fiber including a plurality of cores. In the multi-core fiber, the refractive index distributions of the plurality of cores are different from each other. A plurality of optical signals output from the transmitter 11 are input to different cores in the multi-core fiber and transmitted to the polarization fluctuation detection apparatus 15. For example, the multi-core fiber includes a first core and a second core in which the refractive index distributions thereof are different from each other. In the multi-core fiber, the first optical signal is transmitted using the first core and the second optical signal is transmitted using the second core. In this case, as in the above case in which a plurality of optical fibers are used, the plurality of optical signals are transmitted at different propagation velocities in accordance with a difference between the refractive index distributions of the cores through which they are transmitted.

In the transmission line 13, a plurality of optical signals may be mode-multiplexed in a plurality of modes. In this case, the transmission line 13 includes a multimode fiber. In the multimode fiber, the plurality of optical signals are multiplexed, for example, in Linearly Polarized (LP) modes different from each other. In the multimode fiber, for example, the first optical signal is transmitted in the LP01 mode and the second optical signal is transmitted in the LP11 mode. The group delay time per unit length of the fiber between the modes is, for example, about 8.7 (ns/km). In this case, like in the above case, the plurality of optical signals are transmitted at different propagation velocities in accordance with the mode by which they are transmitted.

In the transmission line 13, a plurality of optical signals may be multiband-multiplexed in a plurality of bands having wavelength bands different from each other. In this case, the transmitter 11 outputs optical signals at a plurality of wavelengths, each of the plurality of wavelengths being within a different frequency band, to the transmission line 13. The plurality of bands include the O band (original-band) at the 18 THz band, the E band (Extended-band) at the 15 THz band, the S band (Short-wavelength-band) at the 9 THz band, the C band (Conventional-band) at the 4.5 THz band, the L band (Long-wavelength-band) at the 7 THz band, and the U band (Ultralong-wavelength-band) at the 5.5 THz band. For example, an optical signal at 1260 nm, the shortest wavelength within the O band, is used as the first optical signal, and an optical signal at 1678 nm, the longest wavelength within the U band is used as the second optical signal. If the chromatic dispersion is 20 μs/nm/km, the group delay time per unit distance is about 8 ns/km for the optical signal at 1260 nm and the optical signal at 1675 nm. In a case where a plurality of optical signals are multiplexed by multiband multiplexing, the plurality of optical signals are transmitted through a transmission line 13 at different propagation velocities.

The above-described methods for multiplexing a plurality of optical signals may be used alone or in combination as appropriate. For example, a combination of fiber multiplexing and multiband multiplexing may be used. In this case, the transmission line 13 may transmit an optical signal at a wavelength of 1260 nm, which is the first optical signal, using the first optical fiber which is a single-mode fiber, and transmit an optical signal at a wavelength of 1675 nm, which is the second optical signal, using a cutoff shifted fiber.

The polarization fluctuation detection apparatus 15 receives a plurality of optical signals transmitted from the transmitter 11 through the transmission line 13. In a case where an external disturbance such as a shock or a vibration is applied to the optical fiber cable at a specific position in the transmission line 13, a polarization fluctuation occurs in each of the plurality of optical signals transmitted through the transmission line 13. The polarization fluctuation detection apparatus 15 detects polarization fluctuations that have occurred in the plurality of received optical signals. The polarization fluctuation detection apparatus 15 estimates, based on the detected polarization fluctuations, a position in the transmission line 13 where the external disturbance is applied, that is, a point where the polarization fluctuation has occurred.

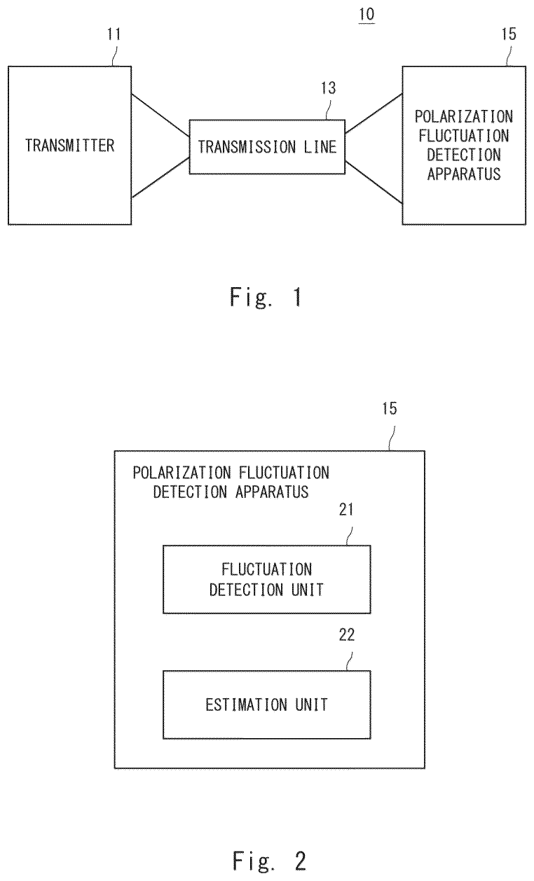

FIG. 2 is a block diagram showing an example of a configuration of the polarization fluctuation detection apparatus 15. The polarization fluctuation detection apparatus 15 includes a fluctuation detection unit 21 and an estimation unit 22. The polarization fluctuation detection apparatus 15 may be physically configured as an apparatus including one or more memories and one or more processors. At least some of the functions of the respective units included in the polarization fluctuation detection apparatus 15 may be implemented by the one or more processors executing processing in accordance with instructions loaded from the one or more memories.

The fluctuation detection unit 21 detects polarization fluctuations of a plurality of optical signals transmitted through the transmission line 13 in a predetermined direction. The fluctuation detection unit 21 includes, for example, a polarizer, a photodetector, and a timer. The fluctuation detection unit 21 monitors a polarization state of each of the plurality of optical signals. In the monitoring of the polarization state, the fluctuation detection unit 21 acquires the amount of polarization fluctuation of each of the plurality of optical signals. The fluctuation detection unit 21 detects a polarization fluctuation in a case where the amount of polarization fluctuation exceeds a predetermined threshold. The fluctuation detection unit 21 measures a difference between the times at which the polarization fluctuations are detected in the plurality of optical signals.

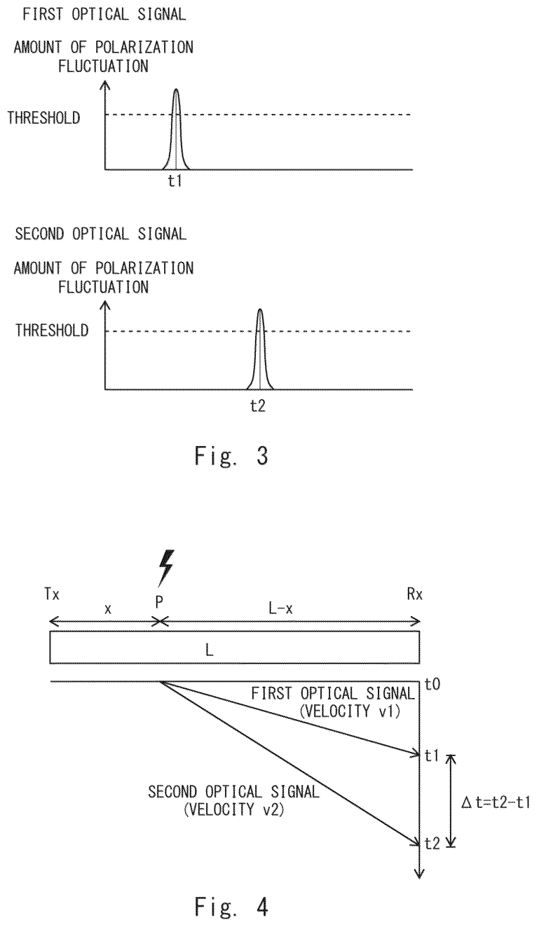

FIG. 3 is a waveform diagram showing a specific example of detection of a polarization fluctuation. For example, the fluctuation detection unit 21 acquires the amount of polarization fluctuation of each of the first optical signal and the second optical signal, each of which amounts of polarization fluctuation may change from second to second. The fluctuation detection unit 21 compares the amount of polarization fluctuation with a predetermined threshold. The fluctuation detection unit 21 detects a time t1 at which the amount of polarization fluctuation has exceeded a threshold for the first optical signal. Further, the fluctuation detection unit 21 detects a time t2 at which the amount of polarization fluctuation has exceeded a threshold for the second optical signal.

The fluctuation detection unit 21 measures a time difference between the time t1 and the time t2. For example, the fluctuation detection unit 21 measures a time difference between the time t1 and the time t2 by starting the operation of a timer at the time t1 and stopping the operation of the timer at the time t2. The time t1 is also referred to as a first time. The time t2 is also referred to as a second time.

The estimation unit 22 estimates a position where polarization fluctuation has occurred in the transmission line 13 based on a difference between the times at which the polarization fluctuations are detected in the plurality of optical signals. For example, in a case where a polarization fluctuation occurs at a certain position in the transmission line 13, the time at which the polarization fluctuation is observed at an end, which is the receiving end, where the polarization fluctuation detection apparatus 15 is disposed changes depending on the propagation velocity of the optical signal. The estimation unit 22 estimates a position where the polarization fluctuation has occurred in the transmission line 13 by using a difference between the times at which the polarization fluctuations are detected in the plurality of optical signals and the propagation velocities of the plurality of optical signals in the transmission line 13.

FIG. 4 is a schematic diagram showing a specific example of estimation of a position where a polarization fluctuation has occurred. In this example, it is assumed that the total length of the transmission line 13 is L [m]. It is assumed that a polarization fluctuation has occurred at a point Pin the transmission line 13, the point P being xm [m] away from a transmitting end Tx where the transmitter 11 is disposed. In this case, a polarization fluctuation that has occurred in the first optical signal and a polarization fluctuation that has occurred in the second optical signal are both detected at a receiving end Rx that is a distance L-x [m] away from the point P.

It is assumed that a propagation velocity of the first optical signal is v1 and a propagation velocity of the second optical signal is v2. It is also assumed that the propagation velocity v1 of the first optical signal is faster than the propagation velocity v2 of the second optical signal. That is, it is assumed that v1>v2. It is assumed that the time at which the polarization fluctuation has occurred is to. In this case, the time t1 at which the polarization fluctuation reaches the receiving end Rx in the first optical signal and the time t2 at which the polarization fluctuation reaches the receiving end Rx in the second optical signal are expressed by the following equations.

$$t 1 = ( L - X ) / v 1 + t 0 \qquad ( 1 )$$

$$t 2 = ( L - X ) / v 2 + t 0 \qquad ( 2 )$$

In a case where v1>v2, the time t2 is later than the time t1. A difference t2−t1 between the time t1 at which the polarization fluctuation reaches the receiving end Rx and the time t2 at which the polarization fluctuation reaches the receiving end Rx is expressed by the following equation.

$$\begin{matrix}t 2 - t 1 = ( L - X ) / v 2 + t 0 - \{ ( L - X ) / v 1 + t 0 \} \\ = ( L - X ) / v 2 - ( L - X ) / v 1 \\ = ( L - X ) ( 1 / v 2 - 1 / v 1 ) \\ = ( L - X ) ( v 1 - v 2 ) / ( v 1 \times v 2 )\end{matrix} \qquad ( 3 )$$

The following equation (4) is obtained by modifying the above equation (3).

$$L - x = v 1 \times v 2 / ( v 1 - v 2 ) \times ( t 2 - t 1 ) \qquad ( 4 )$$

Each of the propagation velocity v1 of the first optical signal and the propagation velocity v2 of the second optical signal is the group velocity of each optical wave and can be calculated or measured from the wavelength and the refractive index distribution of the core. In this case, the distance L-x from the point P to the receiving end can be calculated from a time difference (t2−t1) for the respective polarization fluctuations to reach the receiving end by using the equation (4). Even if polarization fluctuations have occurred at a plurality of points in the transmission line 13, the order of polarization fluctuations that reach the receiving end is the same for the first optical signal and the second optical signal. Therefore, in this example embodiment, even in a case where polarization fluctuations have occurred at a plurality of points in the transmission line, points where the polarization fluctuations have occurred can be correctly estimated.

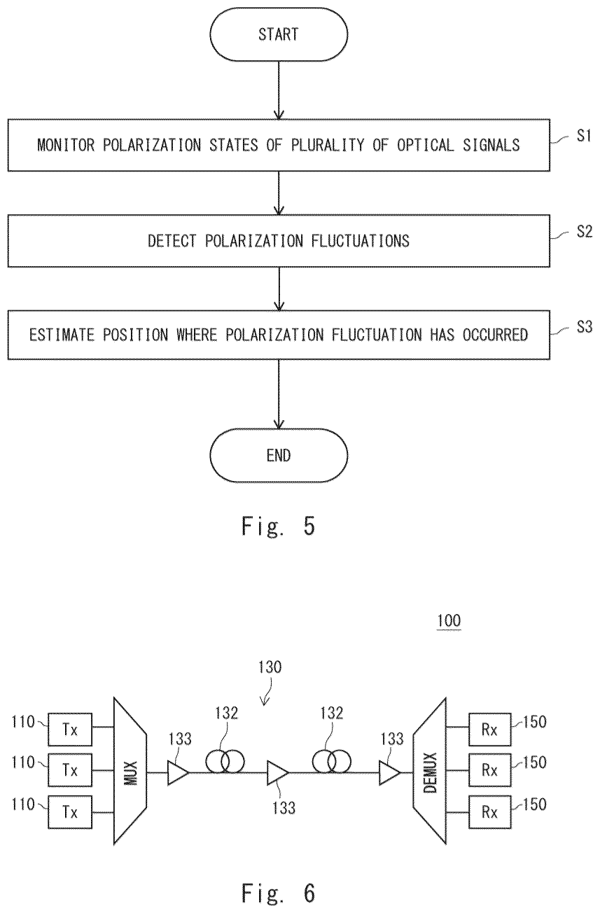

Next, an operation procedure will be described. FIG. 5 is a flowchart showing an operation procedure of the polarization fluctuation detection apparatus 15. The operation procedure of the polarization fluctuation detection apparatus 15 corresponds to a polarization fluctuation detection method. The transmitter 11 transmits a plurality of optical signals having propagation velocities different from each other to the polarization fluctuation detection apparatus 15 through the transmission line 13. In the polarization fluctuation detection apparatus 15, the fluctuation detection unit 21 monitors a polarization state of each of the plurality of optical signals (Step S1).

The fluctuation detection unit 21 detects a polarization fluctuation in each of the plurality of optical signals (Step S2). For example, in Step S2, the fluctuation detection unit 21 detects the time at which the amount of polarization fluctuation exceeds a predetermined threshold in each of the optical signals as the time at which the polarization fluctuation is detected. The estimation unit 22 estimates a position where the polarization fluctuation has occurred based on a difference between the times at which the polarization fluctuations are detected in the plurality of optical signals (Step S3). For example, the estimation unit 22 estimates a position where the polarization fluctuations has occurred in the transmission line 13 based on a difference between the time at which the polarization fluctuation is detected in the first optical signal and the time at which the polarization fluctuation is detected in the second optical signal, the propagation velocity of the first optical signal, and the propagation velocity of the second optical signal.

In this example embodiment, the transmitter 11 outputs a plurality of optical signals to the transmission line 13. In the transmission line 13, the plurality of optical signals are transmitted at propagation velocities different from each other. The polarization fluctuation detection apparatus 15 receives the plurality of optical signals through the transmission line 13. In this case, if the polarization fluctuation has occurred in the transmission line 13, the time required for the polarization fluctuation to be received by the polarization fluctuation detection apparatus 15, which is the receiving end, changes in accordance with the propagation velocities of the optical signals. In the polarization fluctuation detection apparatus 15, the fluctuation detection unit 21 detects a polarization fluctuation in each of the plurality of optical signals. The estimation unit 22 estimates a point where the polarization fluctuation has occurred in the transmission line 13 based on a difference between the times at which the polarization fluctuations are detected in the plurality of optical signals and the propagation velocity of each of the optical signals.

In comparison with the invention disclosed in Japanese Unexamined Patent Publication No. H6-307896, two optical signals transmitted in opposite directions to each other are used in Japanese Unexamined Patent Publication No. H6-307896. In Japanese Unexamined Patent Publication No. H6-307896, a distance between a point where a polarization fluctuation has occurred and a point where the optical signal is received in the transmission line differs between the two signals. In this case, if polarization fluctuations have occurred at a plurality of points, the order in which the polarization fluctuations are detected at both ends may change depending on the positions where the polarization fluctuations have occurred and the timings at which the polarization fluctuations have occurred.

For example, it is assumed that a case is one in which a first polarization fluctuation has occurred in the transmission line and then a second polarization fluctuation has occurred in the transmission line. In this case, in Japanese Unexamined Patent Publication No. H6-307896, the order in which the first polarization fluctuation and the second polarization fluctuation are detected at one end side and the other end side of the transmission line may change depending on the position where each of the polarization fluctuations has occurred and the timing at which each of the polarization fluctuations has occurred. In a case where the polarization fluctuations detected in both of the optical signals cannot be correctly associated with each other, points where the polarization fluctuations have occurred cannot be correctly estimated.

In contrast, in this example embodiment, the polarization fluctuation detection apparatus 15 detects polarization fluctuations using a plurality of optical signals received at one end side of the transmission line 13. The polarization fluctuation detection apparatus 15 uses a difference between the times at which the polarization fluctuations are detected in accordance with a difference between the propagation velocities of the plurality of optical signals. In this case, the order in which the first polarization fluctuation and the second polarization fluctuation are detected in the first optical signal is the same as the order in which the first polarization fluctuation and the second polarization fluctuation are detected in the second optical signal. Therefore, even in a case where polarization fluctuations have occurred at a plurality of locations in the transmission line 13, the polarization fluctuation detection apparatus 15 can correctly estimate positions where the polarization fluctuations have occurred.

The polarization fluctuation detection system 10 may be applied to a communication system such as an optical fiber communication system. FIG. 6 is a block diagram showing an example of a configuration of an optical fiber communication system. In the following description, it is assumed that the communication system is an optical fiber communication system that employs a polarization multiplexing multilevel modulation scheme and performs coherent reception. Further, it is assumed that the communication system is a communication system in which optical signals having a plurality of wavelengths are multiplexed in a Wavelength Division Multiplexing (WDM) scheme. The multiplexing scheme is not limited to the WDM scheme, and a plurality of optical signals may be multiplexed by a spatial multiplexing scheme.

An optical fiber communication system 100 includes a plurality of optical transmitters 110, a multiplexer 120, the transmission line 130, a demultiplexer 140, and a plurality of optical receivers 150. The optical fiber communication system 100 constitutes, for example, a terrestrial metro communication system or an optical submarine cable system.

The optical transmitter 110 converts a plurality of transmission data into a polarization multiplexed signal. The multiplexer 120 multiplexes a plurality of polarization multiplexed signals being output from the plurality of optical transmitters 110. The transmission line 130 transmits the optical signal being output from the multiplexer 120 to the optical receiver 150. The optical transmitter 110 is also referred to as Tx.

The transmission line 130 includes an optical fiber 132 and an optical amplifier 133. The optical fiber 132 guides an optical signal transmitted from the optical transmitter 110. The optical amplifier 133 amplifies the optical signal and compensates for propagation loss in the optical fiber 132. The optical amplifier 133 is configured, for example, as an erbium doped fiber amplifier (EDFA).

The demultiplexer 140 demultiplexes the polarization multiplexed signal being multiplexed by the WDM, and converts the polarization multiplexed signal being multiplexed by the WDM into a plurality of polarization multiplexed signals. The demultiplexer 140 outputs the plurality of polarization multiplexed signals to the plurality of optical receivers 150. Each of the optical receivers 150 receives a polarization multiplexed signal transmitted from an associated optical transmitter 110. The optical receiver 150 is also referred to as Rx.

Although FIG. 6 illustrates an example in which the optical fiber communication system 100 includes three optical transmitters 110 and three optical receivers 150, the number of the optical transmitters 110 and the optical receivers 150 is not limited to three. Although FIG. 6 illustrates an example in which the transmission line 130 includes three optical amplifiers 133, the number of the optical amplifiers 133 in the transmission line 130 is not limited to three.

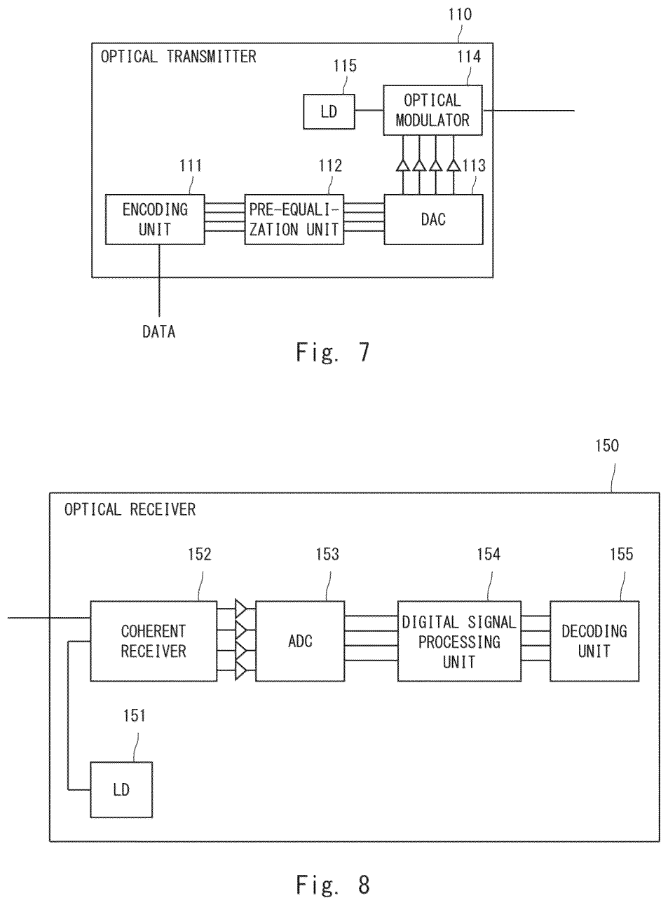

FIG. 7 is a block diagram showing an example of a configuration of the optical transmitter 110. The optical transmitter 110 includes an encoding unit 111, a pre-equalization unit 112, a digital analog converter (DAC) 113, an optical modulator 114, and a laser diode (LD) 115. The encoding unit 111 encodes data. The encoding unit 111 outputs, for example, four sequences of signals which are in-phase (I) components and quadrature (Q) components of X polarization and Y polarization.

The pre-equalization unit 112 performs pre-equalization to compensate, for example, distortion of a device in the optical transmitter in advance for the four sequences of encoded signals. The pre-equalization unit 112 includes, for example, multiple-input and multiple-output (MIMO) filters having I component and Q component as input and output for each polarization. The MIMO filter compensates for distortion occurring in the I component and Q component in each polarization and distortion occurring in the optical transmitter 110, such as crosstalk occurring between the IQ.

The DAC 113 converts the four sequences of signals on which pre-equalization has been performed into analog electrical signals. The DAC 113 inputs the converted analog electrical signal to the optical modulator 114. An electric amplifier is arranged between the DAC 113 and the optical modulator 114, and an analog electric signal whose amplitude is amplified by the electric amplifier is input to the optical modulator 114.

The LD 115 outputs continuous wave (CW) lights. The optical modulator 114 is a modulator that modulates the CW lights being output from the LD 115 in accordance with four sequences of analog electric signals being input from the DAC 113, and that generates a polarization multiplexed signal such as a polarization multiplexed quadrature-amplitude modulation (QAM) signal. The optical modulator 114 includes, for example, a Mach-Zehnder (MZ) modulator. The optical modulator 114 outputs the generated polarization multiplexed signal to the multiplexer 120.

FIG. 8 is a block diagram showing an example of a configuration of the optical receiver 150. The optical receiver 150 includes an LD 151, a coherent receiver 152, an analog digital converter (ADC) 153, a digital signal processing unit 154, and a decoding unit 155. The LD 151 outputs CW light that becomes local oscillator light. The coherent receiver 152 is configured as a polarization diversity coherent receiver. The coherent receiver 152 performs coherent detection on the optical signal transmitted through the optical fiber 132 by using the CW light being output from the LD 151. The coherent receiver 152 outputs four sequences of received signals (electric signals) equivalent to the I component and the Q component of the coherently detected X polarization and Y polarization.

The received signal being output from the coherent receiver 152 is input to the ADC 153 via an electric amplifier. The ADC 153 samples the received signal being output from the coherent receiver 152 and converts the received signal into a digital signal. The ADC 153 outputs the converted digital signal to the digital signal processing unit 154. The digital signal processing unit 154 performs digital signal processing on the four sequences of received signals sampled by the ADC 153 and demodulates the received signals. The digital signal processing unit 154 includes an equalization filter, and the equalization filter compensates for various distortions included in the digital signal. Specifically, the digital signal processing unit 154 performs, for example, chromatic dispersion compensation, carrier phase compensation, and polarization fluctuation compensation.

In the optical fiber communication system 100, at least two of the optical transmitters 110 may be used as the transmitter 11 shown in FIG. 1. In this case, the optical signals output from the at least two optical transmitters 110 are multiplexed in the transmission line 130 by fiber multiplexing, core multiplexing, mode multiplexing, wavelength multiplexing, or a combination of two or more of them. In the optical receiver 150, the optical signals transmitted through the transmission line 130 are branched to the polarization fluctuation detection apparatus 15 shown in FIG. 1, and the polarization fluctuation detection apparatus 15 may estimate a position where the polarization fluctuation has occurred in the transmission line 130.

Alternatively, the optical fiber communication system 100 may include the transmitter 11 and the polarization fluctuation detection apparatus 15 shown in FIG. 1 in addition to the optical transmitters 110 and the optical receivers 150. In this case, the transmitter 11 may output main signals, that is, a plurality of optical signals at wavelengths different from the wavelengths of the polarization multiplexed signals output by a plurality of the optical transmitters 110. At least some of the plurality of optical signals output by the transmitter 11 may be used as Optical Supervisory Channel (OSC) signals or monitoring optical signals used for an operation setting in the transmission line 130 and a state monitoring of the transmission line 130.

In the optical fiber communication system 100, a plurality of optical signals output from the transmitter 11 are branched from the transmission line 130 to the polarization fluctuation detection apparatus 15. For example, a plurality of optical signals output from the transmitter 11 may be selectively branched from the optical fiber to the polarization fluctuation detection apparatus 15 by using a demultiplexer such as a wavelength demultiplexer or a wavelength selective switch at the receiving end.

In the optical fiber communication system 100, the number of sets of the transmitters 11 and the polarization fluctuation detection apparatus 15 is not limited to one. The optical fiber communication system 100 may include a plurality of sets of the transmitter 11 and the polarization fluctuation detection apparatus 15. For example, the optical fiber communication system 100 may include a set of the transmitter 11 and the polarization fluctuation detection apparatus for each predetermined span in the transmission line 130.

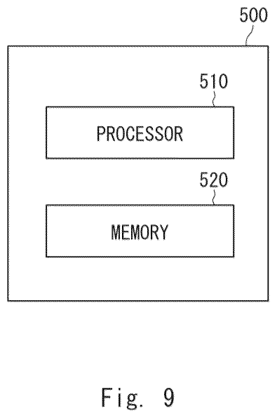

Next, a physical configuration of the polarization fluctuation detection apparatus 15 will be described. FIG. 9 is a block diagram showing an example of a configuration of a signal processing circuit that may be used as the polarization fluctuation detection apparatus 15. A digital signal processing circuit 500 includes one or more processors 510 and one or more memories 520. In the digital signal processing circuit 500, the one or more processors 510 load(s) a program(s) stored in the one or more memories 520 and execute(s) processing on the loaded program(s). By doing so, at least some of the functions of the fluctuation detection unit 21 and the estimation unit 22 may be implemented.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a Compact Disc (CD), a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### [Supplementary Note 1]

A polarization fluctuation detection method comprising:
detecting polarization fluctuations of a plurality of optical signals transmitted through a transmission line in a predetermined direction at propagation velocities different from each other; and estimating a position where the polarization fluctuation has occurred in the transmission line based on a difference between times at which the polarization fluctuations are detected in the plurality of optical signals.

### [Supplementary Note 2]

The polarization fluctuation detection method according to supplementary note 1, wherein the plurality of optical signals are transmitted from a first end of the transmission line toward a second end of the transmission line, and the polarization fluctuations of the plurality of optical signals are detected at the second end.

### [Supplementary Note 3]

The polarization fluctuation detection method according to supplementary note 1 or 2, wherein the transmission line comprises a plurality of optical fibers in which refractive index distributions thereof are different from each other, and the plurality of optical signals are transmitted using the plurality of optical fibers.

[Supplementary note 4]

The polarization fluctuation detection method according to any one of supplementary notes 1 to 3, wherein the transmission line comprises a multi-core fiber comprising a plurality of cores in which refractive index distributions thereof are different from each other, and the plurality of optical signals are transmitted using the plurality of cores of the multi-core fiber.

[Supplementary note 5]

The polarization fluctuation detection method according to any one of supplementary notes 1 to 4, wherein the transmission line comprises a multimode fiber, and the plurality of optical signals are transmitted in transmission modes different from each other in the multimode fiber.

[Supplementary note 6]

The polarization fluctuation detection method according to any one of supplementary notes 1 to 5, wherein the plurality of optical signals include optical signals at a plurality of wavelengths, each of the plurality of wavelength being within a frequency band that is different from one another.

[Supplementary note 7]

The polarization fluctuation detection method according to any one of supplementary notes 1 to 6, wherein
the plurality of optical signals include a first optical signal and a second optical signal, and
a position where the polarization fluctuation has occurred in the transmission line are estimated based on a difference between a first time at which the polarization fluctuation exceeds a threshold in the first optical signal and a second time at which the polarization fluctuation exceeds a threshold in the second optical signal, a propagation velocity of the first optical signal in the transmission line, and a propagation velocity of the second optical signal in the transmission line.
   [Supplementary note 8]

A polarization fluctuation detection apparatus comprising:
a fluctuation detection unit configured to detect polarization fluctuations of a plurality of optical signals transmitted through a transmission line in a predetermined direction at propagation velocities different from each other; and
an estimation unit configured to estimate a position where the polarization fluctuation has occurred in the transmission line based on a difference between times at which the polarization fluctuations are detected in the plurality of optical signals.

### [Supplementary Note 9]

The polarization fluctuation detection apparatus according to supplementary note 8, wherein the plurality of optical signals are transmitted from a first end of the transmission line toward a second end of the transmission line, and the fluctuation detection unit detects the polarization fluctuations of the plurality of optical signals at the second end.

### [Supplementary Note 10]

A polarization fluctuation detection system comprising:
a transmitter configured to output a plurality of optical signals; and
a polarization fluctuation detection apparatus configured to receive the plurality of optical signals output from the transmitter through a transmission line through which the plurality of optical signals are transmitted in a predetermined direction at propagation velocities different from each other, and wherein
the polarization fluctuation detection apparatus comprising:
   a fluctuation detection unit configured to detect polarization fluctuations of the plurality of received optical signals; and
   an estimation unit configured to estimate a position where the polarization fluctuation has occurred in the transmission line based on a difference between times at which the polarization fluctuations are detected in the plurality of optical signals.

Some or all of elements (e.g., structures and functions) specified in supplementary notes 2 to 7 dependent on supplementary note 1 may also be dependent on supplementary notes 8 and 10 in dependency similar to that of supplementary notes 2 to 7 on supplementary note 1. Some or all of elements specified in any of supplementary notes may be applied to various types of hardware, software, and recording means for recording software, systems, and methods.

What is claimed is:

1. A polarization fluctuation detection method comprising:
detecting polarization fluctuations of a plurality of optical signals transmitted through a transmission line in a predetermined direction at propagation velocities different from each other; and
estimating a position where the polarization fluctuation has occurred in the transmission line based on a difference between times at which the polarization fluctuations are detected in the plurality of optical signals.

2. The polarization fluctuation detection method according to claim 1, wherein the plurality of optical signals are transmitted from a first end of the transmission line toward a second end of the transmission line, and the polarization fluctuations of the plurality of optical signals are detected at the second end.

3. The polarization fluctuation detection method according to claim 1, wherein the transmission line comprises a plurality of optical fibers in which refractive index distributions thereof are different from each other, and the plurality of optical signals are transmitted using the plurality of optical fibers.

4. The polarization fluctuation detection method according to claim 1, wherein the transmission line comprises a multi-core fiber comprising a plurality of cores in which refractive index distributions thereof are different from each other, and the plurality of optical signals are transmitted using the plurality of cores of the multi-core fiber.

5. The polarization fluctuation detection method according to claim 1, wherein the transmission line comprises a multimode fiber, and the plurality of optical signals are transmitted in transmission modes different from each other in the multimode fiber.

6. The polarization fluctuation detection method according to claim 1, wherein the plurality of optical signals include optical signals at a plurality of wavelengths, each of the plurality of wavelength being within a frequency band that is different from one another.

7. The polarization fluctuation detection method according to claim 1, wherein
the plurality of optical signals include a first optical signal and a second optical signal, and
a position where the polarization fluctuation has occurred in the transmission line are estimated based on a difference between a first time at which the polarization fluctuation exceeds a threshold in the first optical signal and a second time at which the polarization fluctuation exceeds a threshold in the second optical signal, a propagation velocity of the first optical signal in the transmission line, and a propagation velocity of the second optical signal in the transmission line.

8. A polarization fluctuation detection apparatus comprising:
at least one memory storing instructions; and
at least one processor configured to execute the instructions to:
detect polarization fluctuations of a plurality of optical signals transmitted through a transmission line in a predetermined direction at propagation velocities different from each other; and
estimate a position where the polarization fluctuation has occurred in the transmission line based on a difference between times at which the polarization fluctuations are detected in the plurality of optical signals.

9. The polarization fluctuation detection apparatus according to claim 8, wherein the plurality of optical signals are transmitted from a first end of the transmission line toward a second end of the transmission line, and the at least one processor is configured to execute the instructions to detect the polarization fluctuations of the plurality of optical signals at the second end.

10. A polarization fluctuation detection system comprising:
a transmitter configured to output a plurality of optical signals; and
a polarization fluctuation detection apparatus configured to receive the plurality of optical signals output from the transmitter through a transmission line through which the plurality of optical signals are transmitted in a predetermined direction at propagation velocities different from each other, and wherein the polarization fluctuation detection apparatus comprising:
at least one memory storing instructions; and
at least one processor configured to execute the instructions to:
detect polarization fluctuations of the plurality of received optical signals; and
estimate a position where the polarization fluctuation has occurred in the transmission line based on a difference between times at which the polarization fluctuations are detected in the plurality of optical signals.
